(19) United States
(12) Patent Application Publication
(10) Pub. No.: US 2016/0225510 A1
(43) Pub. Date: Aug. 4, 2016

(54) NETWORK TRANSFORMER

(71) Applicant: SUMIDA ELECTRIC (H.K.) COMPANY LIMITED, Hong Kong (CN)

(72) Inventors: Jiayu Chen, Hong Kong (CN); Xiaohang Zhuang, Hong Kong (CN)

(21) Appl. No.: 14/608,430

(22) Filed: Jan. 29, 2015

(51) Int. Cl. H01F 27/02; H01F 27/29

(52) U.S. Cl. CPC H01F 27/02; H01F 27/29

(57) ABSTRACT

A network transformer, including a housing and a partition member, wherein, the housing defines a chamber therein, a plurality of external pins are provided at edge of the housing, the partition member is mounted in the chamber and divides the chamber into two spaces, in each of which a plurality of magnetic cores are mounted, the magnetic core is winded at least with a coil, and the external pin is connected to the ends of the coil. The network transformer can improve insulating effect and anti-interference capability between internal channels, and be conducive to make the most use of the product space.

### FIELD

The present disclosure relates generally to the field of electronic technology, and more particularly, to a network transformer.

### BACKGROUND

As the rapid development of electronic technology, a network magnetic device which is used in the internet, such as network transformer, is used extensively. A common network transformer generally includes a housing which defines a chamber therein, and coil components provided in the chamber. The network transformer generally plays an important role in signal transmission, impedance matching, waveform repairing, clutter signal suppression and high voltage isolation. In order to realize the above functions, the network transformer may include ten to twenty coil components as needed, and at this point, the insulating capability between lines in the network transformer and anti-interference capability between input and output channels will directly affect the quality of the network transformer itself. To overcome these disadvantages, common practice is to configure the coil components to be connected in the chamber in a certain order and to insulate and encapsulate the coil components in a glue-pouring way, so as to achieve the insulating capability and the anti-interference capability. But such a network transformer demands high quality due to the fact that all the coil components are placed in a same space, and though the insulating capability has been achieved, anti-interference capability between internal channels still remains to be solved.

### SUMMARY

In view of the above, an objective of the present disclosure is to provide a network transformer, which can improve insulating effect and anti-interference capability between internal channels, and be conducive to make full use of the product space.

Described herein is a network transformer, including a housing and a partition member, wherein the housing defines a chamber therein, a plurality of external pins are provided at edge of the housing, the partition member is mounted in the chamber and divides the chamber into two spaces, in each of which a plurality of magnetic cores are mounted, the magnetic core is winded at least with a coil, and the external pin is connected to the end of the coil.

Compared with the conventional network transformer which places the coil components in a same space, the network transformer described herein can enhance the anti-interference capability between internal channels of the transformer to ensure product quality via forming a double-floor space structure by the partition member and providing each floor space with magnetic cores. In addition, the network transformer described herein also can make full use of the product space, improve space utilization of the chamber, and ensure the insulation distance between the ends of the coils out from the magnetic cores and the insulation distance between the different functional magnetic cores.

Also described herein is a network transformer wherein the partition member is provided with a plurality of wiring grooves arranged spaced apart from one another along the arranging direction of the external pins, the external pins are on a same plane serving as a reference plane, and one side of the partition member where the wiring grooves are provided faces towards the reference plane. The configuration of the wiring grooves can be beneficial to better ensure the product quality of insulation distance between the ends of the coils out from the magnetic cores.

Also described herein is a network transformer wherein the partition member is provided with a plurality of bumps arranged spaced apart from one another, and the wiring groove is formed by two adjacent bumps.

Also described herein is a network transformer wherein the partition member is provided with at least two rows of bumps, there is a space interval between every two adjacent bumps in each row of bumps, and the space intervals formed by one row of bumps correspond with those formed by other rows of bumps, so as to form the wiring grooves.

In conclusion, the distance between the two adjacent wiring grooves can further ensure the insulation distance.

Also described herein is a network transformer wherein the housing includes a top surface portion, two first side surface portions disposed opposite to each other and two second side surface portions disposed opposite to each other, tops of the two first side surface portions and the two second side surface portions are respectively connected to the top surface portion to form the chamber, the external pins are provided at bottom edge of the first side surface portions, and the partition member is parallel to the top surface portion. The partition member can thus divide the chamber into two spaces by the above structure.

Also described herein is a network transformer wherein the chamber is provided with a support plate connected to the top surface portion and the first side surface portions, and the partition member is mounted in the chamber by the support plate.

Also described herein is a network transformer wherein the support plate has an end face cooperative with the partition member, the end face is provided with a protrusion, the partition member is provided with a cavity configured to engage with the protrusion.

Therefore, the partition member can be more firmly mounted in the chamber and divide the chamber into two spaces by the supporting of the support plate and the cooperation of the protrusion and the cavity.

Also described herein is a network transformer wherein the chamber is provided with a support plate connected to the first side surface portion, and a top of the support plate is provided with a stepped surface cooperative with the partition member.

Also described herein is a network transformer wherein the second side surface portion is provided with a hole, and a side of the partition member is provided with a convex column configured to engage with the hole.

Also described herein is a network transformer wherein an inner wall of the second side surface portion is provided with a projection configured to support the partition member.

Therefore, the partition member can be also more firmly mounted in the chamber and divide the chamber into two spaces by the supporting of the stepped surface of the support plate and the projection and the engagement between the hole and the convex column.

The network transformer described herein has the following advantages.

The anti-interference capability between internal channels of the transformer can be effectively improved to solve the quality problem exiting in a conventional network transformer, by a double-floor space structure formed by the partition member; and

The double-floor space structure formed by the partition member is conducive not only to save product space to improve space utilization of the chamber, but also to ensure the insulation distance between the ends of the coils out from the magnetic cores and the insulation distance between different functional magnetic cores to further ensure product quality.

### BRIEF DESCRIPTION OF THE DRAWINGS

The accompanying drawings, which are incorporated into and constitute a part of this specification, illustrate one or more examples of embodiments and, together with the description of example embodiments, serve to explain the principles and implementations of the embodiments. Wherever possible, the same reference numbers are used throughout the drawings to refer to the same or like elements of an embodiment.

FIG. 1 is a schematic diagram illustrating a network transformer in accordance with certain embodiments of the present disclosure.

FIG. 2 is a section diagram illustrating a network transformer in accordance with Embodiment One of the present disclosure.

FIG. 3 is a schematic diagram illustrating an assembly of a housing and a support plate in accordance with Embodiment One of the present disclosure.

FIG. 4 is a space diagram illustrating a support plate in accordance with Embodiment One of the present disclosure.

FIG. 5 is a first space diagram illustrating a housing in accordance with Embodiment Two of the present disclosure.

FIG. 6 is a second space diagram illustrating a housing in accordance with Embodiment Two of the present disclosure.

FIG. 7 is a space diagram illustrating a support plate in accordance with Embodiment Two of the present disclosure.

### DESCRIPTION OF REFERENCE NUMBERS

10 housing;
11 first side surface portion;
12 second side surface portion;
121 hole;
122 projection;
13 top surface portion;
14 support plate;
141 protrusion;
142 stepped surface;
15 external pin;
20 partition member;
21 bump;
22 wiring groove;
23 cavity;
24 convex column; and
30 magnetic core.

### DETAILED EMBODIMENTS

In the following description of embodiments, reference is made to the accompanying drawings which form a part hereof, and in which it is shown by way of illustration specific embodiments of the disclosure that can be practiced. It is to be understood that other embodiments can be used and structural changes can be made without departing from the scope of the disclosed embodiments.

### Embodiment One

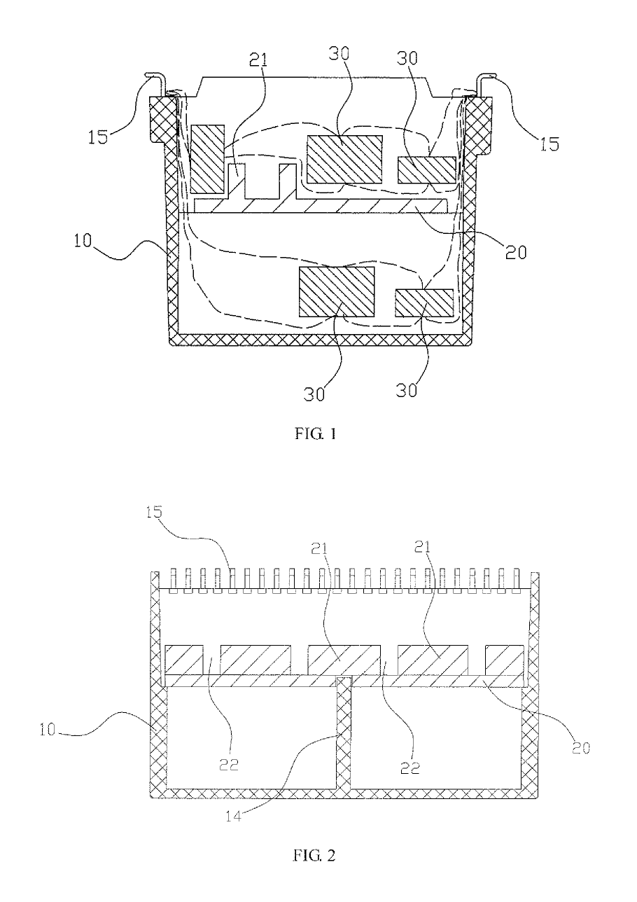

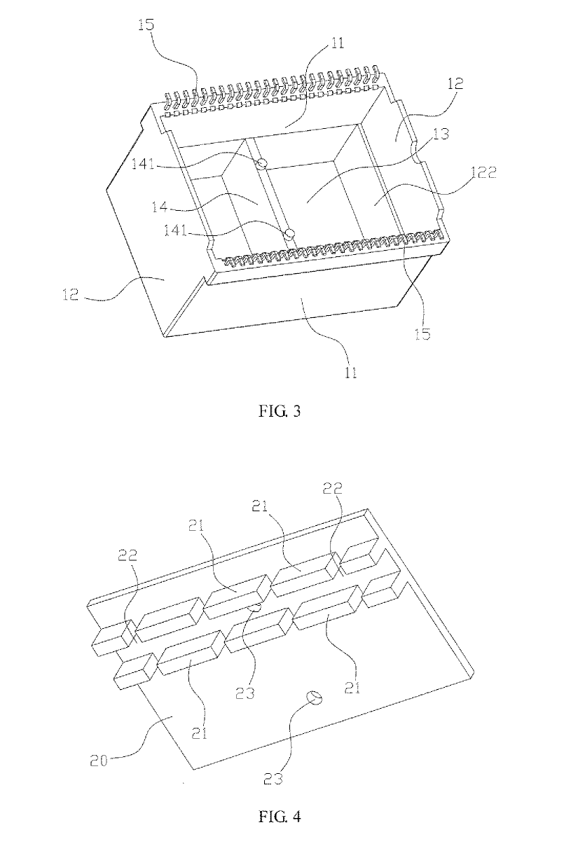

As shown in FIGS. 1-4, a network transformer includes a housing 10 and a partition member 20, wherein the housing 10 defines a chamber therein, a plurality of external pins 15 are provided at edge of the housing 10, the partition member 20 is mounted in the chamber and divides the chamber into two spaces, in each of which a plurality of magnetic cores 30 are mounted, the magnetic core 30 is winded with a coil, and the external pin 15 is connected to the end of the coil.

In the embodiment, the housing 10 includes a top surface portion 13, two first side surface portions 11 disposed opposite to each other and two second side surface portions 12 disposed opposite to each other, tops of the two first side surface portions 11 and the two second side surface portions 12 are respectively connected to the top surface portion 13 to form the chamber, the external pins 15 are provided at bottom edge of the first side surface portions 11. The chamber is provided with a support plate 14 connected to the top surface portion 13 and the first side surface portions 11, the partition member 20 is mounted in the chamber by the support plate 14 and the partition member 20 is parallel to the top surface portion 13. The support plate 14 has an end face cooperative with the partition member 20, the end face is provided with a protrusion 141, the partition member 20 is provided with a cavity 23 configured to engage with the protrusion 141. An inner wall of the second side surface portion 12 is provided with a projection 122 configured to support the partition member 20.

In addition, the partition member 20 is provided with a plurality of bumps 21 arranged in two rows, there is a space interval between every two adjacent bumps 21 in each row of bumps, and the space intervals formed by one row of bumps 21 correspond with those formed by another row of bumps, so as to form the wiring grooves 22. A plurality of such wiring grooves 22 are formed and arranged spaced apart from one another along the arranging direction of the external pins 15. The external pins 15 are on a same plane serving as a reference plane, and one side of the partition member 20 where the wiring grooves 22 are provided faces towards the reference plane.

### Embodiment Two

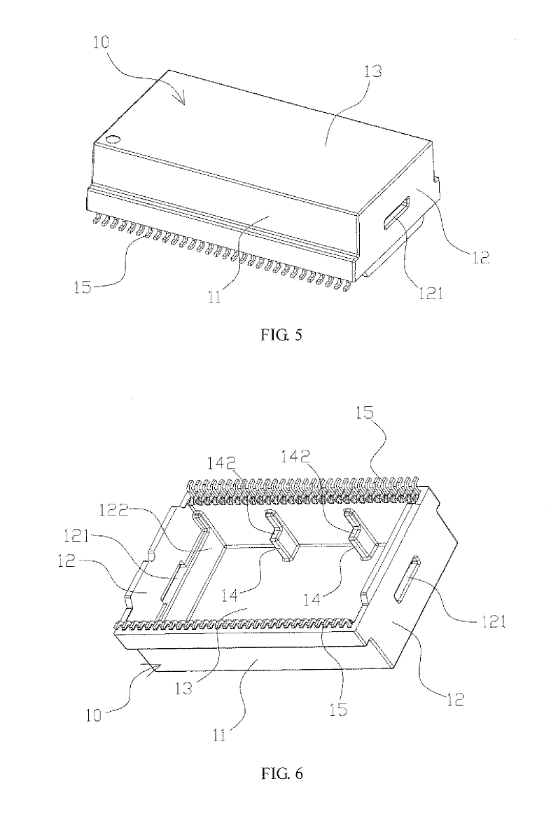

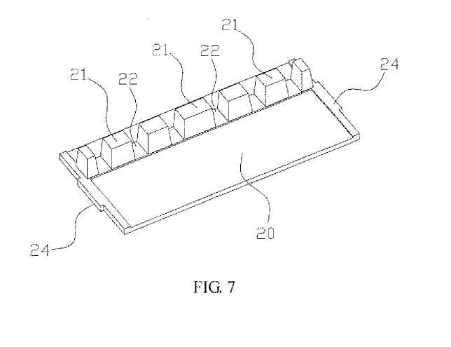

As shown in FIGS. 1 and 5-7, a network transformer includes a housing 10 and a partition member 20, wherein the housing 10 defines a chamber therein, a plurality of external pins 15 are provided at edge of the housing 10, the partition member 20 is mounted in the chamber and divides the chamber into two spaces which are respectively provided with an even number of magnetic cores 30, the magnetic core 30 is winded with a coil, and the external pin 15 is connected to the end of the coil.

In the embodiment, the housing 10 includes a top surface portion 13, two first side surface portions 11 disposed opposite to each other and two second side surface portions 12 disposed opposite to each other, tops of the two first side surface portions 11 and the two second side surface portions 12 are respectively connected to the top surface portion 13 to form the chamber, the external pins 15 are provided at bottom edge of the first side surface portions 11. The chamber is provided with a support plate 14 connected to the first side surface portion 11, a top of the support plate 14 is provided with a stepped surface 142 cooperative with the partition member 20, and the partition member 20 is parallel to the top surface portion 13. The second side surface portion 12 is provided with a hole 121, and a side of the partition member 20 is provided with a convex column 24 configured to engage with the hole 121. An inner wall of the second side surface portion 12 is provided with a projection 122 configured to support the partition member 20.

In addition, the partition member is provided with a plurality of bumps 21 arranged spaced apart from one another, and the wiring groove 22 is formed between two adjacent bumps 21. A plurality of such wiring grooves 22 are formed and arranged spaced apart from one another along the arranging direction of the external pins 15. The external pins 15 are on a same plane serving as a reference plane, and one side of the partition member 20 where the wiring grooves 22 are provided faces towards the reference plane.

The network transformers according to Embodiment One and Two have the following advantages.

Compared with the conventional network transformer which places the coil components in a same space, the network transformer described herein can enhance anti-interference capability between internal channels of the transformer to solve the quality problem exiting in a conventional network transformer via forming a double-floor space structure by the partition member 20 and providing each floor space with magnetic cores 30;

The double-floor space structure formed by the partition member 20 is conducive not only to save product space to improve space utilization of the chamber, but also to ensure the insulation distance between the ends of the coils out from the magnetic cores 30 and the insulation distance between different functional magnetic cores 30 to further ensure product quality;

The insulation distance between the ends of the coils out from the magnetic cores 30 can be further ensured by providing wiring grooves 22 on the partition member 20; and

The partition member 20 can be more firmly mounted in the chamber and divide the chamber into two spaces by the supporting of the support plate 14 and the projection 122, the cooperation of the protrusion 23 and the cavity 141, and the engagement between the hole 121 and the convex column 24.

The embodiments are chosen and described in order to explain the principles of the disclosure and their practical application so as to activate those skilled in the art to utilize the disclosure and various embodiments and with various modifications as are suited to the particular use contemplated. Alternative embodiments will become apparent to those skilled in the art to which the present disclosure pertains without departing from its spirit and scope. Accordingly, the scope of the present disclosure is defined by the appended claims rather than the foregoing description and the exemplary embodiments described therein.

What is claimed is:

1. A network transformer, comprising a housing and a partition member, wherein the housing defines a chamber therein, a plurality of external pins are provided at edge of the housing, the partition member is mounted in the chamber and divides the chamber into two spaces, in each of which a plurality of magnetic cores are mounted, each of the magnetic core is winded at least with a coil, the ends of the coil is connected to the external pin.

2. The network transformer of claim 1, wherein the partition member is provided with a plurality of wiring grooves arranged spaced apart from one another along the arranging direction of the external pins, the external pins are on a same plane serving as a reference plane, and one side of the partition member where the wiring grooves are provided faces towards the reference plane.

3. The network transformer of claim 2, wherein the partition member is provided with a plurality of bumps arranged spaced apart from one another, and the wiring groove is formed by two adjacent bumps.

4. The network transformer of claim 2, wherein the partition member is provided with a plurality of bumps arranged in at least two rows, there is a space interval between every two adjacent bumps in each row of bumps, and the space intervals formed by one row of bumps correspond with those formed by other rows of bumps, so as to form the wiring grooves.

5. The network transformer of claim 1, wherein the housing comprises a top surface portion, two first side surface portions disposed opposite to each other and two second side surface portions disposed opposite to each other, tops of the two first side surface portions and the two second side surface portions are respectively connected to the top surface portion to form the chamber, the external pins are provided at bottom edge of the first side surface portions, and the partition member is parallel to the top surface portion.

6. The network transformer of claim 5, wherein the chamber is provided with a support plate connected to the top surface portion and the first side surface portions, and the partition member is mounted in the chamber by the support plate.

7. The network transformer of claim 6, wherein the support plate has an end face cooperative with the partition member, wherein the end face is provided with a protrusion, the partition member is provided with a cavity configured to engage with the protrusion.

8. The network transformer of claim 5, wherein the chamber is provided with a support plate connected to the first side surface portion, and a top of the support plate is provided with a stepped surface cooperative with the partition member.

9. The network transformer of claim 8, wherein the second side surface portion is provided with a hole, and a side of the partition member is provided with a convex column configured to engage with the hole.

10. The network transformer of claim 5, wherein an inner wall of the second side surface portion is provided with a projection configured to support the partition member.
